(19) United States
(12) Patent Application Publication
(10) Pub. No.: US 2015/0377606 A1
(43) Pub. Date: Dec. 31, 2015

(54) PROJECTION SYSTEM

(71) Applicant: NIKON METROLOGY N.V., Heverlee (BE)

(72) Inventor: Hans Thielemans, Rotselaar (BE)

(73) Assignee: Nikon Metrology N.V., Heverlee (BE)

(21) Appl. No.: 14/769,730

(22) PCT Filed: Feb. 24, 2014
(86) PCT No.: PCT/EP2014/053544

§ 371 Date: Aug. 21, 2015

Related U.S. Application Data
(60) Provisional application No. 61/768,972, filed on Feb. 25, 2013.

(30) Foreign Application Priority Data
Feb. 25, 2013 (EP) 13156610.1

(51) Int. Cl. G01B 11/00; G01B 11/02; G01B 21/04; H04N 9/31

(52) U.S. Cl. CPC G01B 11/002; H04N 9/3194; G01B 11/02; G01B 21/047

(57) ABSTRACT

The present invention relates to a metrology system (100) for dimensional measurement of an object (200) comprising a light-projection device (110), LPD, configured to project an image (112) onto the object (200); a position-measurement device (120), PMD, having a measurement volume, configured to determine the position and/or the orientation of the LPD (110) disposed within the measurement volume; a dimensional acquisition device (140), DAD, that is an optical non-contact probe rigidly attached to the LPD configured to acquire dimensional data of the object (200); and an adjustment unit (130) configured to adjust the projected image (112) to have an essentially static appearance in relation to the object (200), which adjustment is responsive to movement of the LPD (110) detected by the PMD (120); wherein the image projected by the LPD (110) conveys feedback information to the user responsive to dimensional acquisition by the DAD (140).

### FIELD OF THE INVENTION

The invention relates to a projection system comprising a light-projection device, configured to adjust the projected image responsive to movement of the light-projection device.

### BACKGROUND OF THE INVENTION

Special projecting methods are able to display an image with reference marks directly onto an object, allowing accurate positioning of a tool with respect to a predefined reference point. Such methods may be used for accurately processing sheet material (such as sheet metal, sheet composites, and sheet foil). Usually, the sheet material is positioned in a fixed setup with respect to a fixed projector. An image is projected onto the sheet material, wherein the image serves as a positional reference for a manual, operator guided process (such as sheet cutting, drilling and riveting, or application of decals).

The projector techniques known in the art mostly use a fixed position of the projector, where the position of the sheet can be manually adjusted until reference marks of the image coincide with reference marks of the sheet. For example, the edges of a sheet with known dimensions may be used as such a reference mark. Once properly aligned, the other position references in the image can be used to manually position a tool (such as a marker pen, cutter, or drill) and perform the required action. This method is considered a promising alternative to the traditionally used hard templates.

### SUMMARY OF SOME EMBODIMENTS OF THE INVENTION

The present invention provides a metrology system (100) for dimensional measurement of an object (200) comprising:
a light-projection device (110), LPD, configured to project an image (112) onto the object (200);
a position-measurement device (120), PMD, having a measurement volume, configured to determine the position and/or the orientation of the LPD (110) disposed within the measurement volume;
a dimensional acquisition device (140), DAD, that is an optical non-contact probe rigidly attached to the LPD configured to acquire dimensional data of the object (200); and
an adjustment unit (130) configured to adjust the projected image (112) to have an essentially static appearance in relation to the object (200), which adjustment is responsive to movement of the LPD (110) detected by the position-measurement device (120), PMD,

wherein the image projected by the LPD (110) conveys feedback information to the user responsive to dimensional acquisition by the DAD (140).

The the adjustment unit (130) may further comprises a processing device (131), configured to receive signals from the PMD (120), process them and output signals to the LPD (111), wherein the processing device (131) is configured to adjust the position and/or orientation of the projected image (112) to have an essentially static appearance in relation to the object (200). The DAD (140) may be a laser scanner. The processing device (131) may be further configured to:
receive a reference model of the object (200);
receive data from the PMD (120) as to the position and/or orientation of the LPD (110) relative to the object (200); and
adjust the projected image responsive to the data received from the PMD (120) using the reference model to calculate the adjustment.

The processing device (131) may be further configured to:
receive a reference model of the object (200);
receive data from the DAD (140) as to the acquired dimensions of the object (200); and
adjust the content of the projected image such that the feedback information indicates geometrical deviations between the acquired dimensions of the object (200) and the reference model.

The geometrical deviations may relate to a dimensional verification of geometrical features of the object (200).

The processing device (131) is further configured such that the feedback information includes suggestions of remedial steps to correct the geometrical deviations in the object.

The processing device (131) may be further configured to:
receive data from the DAD (140) as to the acquired dimensions of the object (200); and
adjust the content of the projected image such that the feedback information indicates a local quality of the acquired dimensions of the object (200).

The content of the project image is continuously updated during dimensional acquisition. The LPD (110) may project the image (112) along a projection beam (114), wherein the LPD (110) is configured to allow spatial adjustment of the direction of the projection beam (114). The PMD (120) may be configured to determine the 6 degrees of freedom, 6DOF, related to the position and the orientation of the LPD (110) in relation to the object (200). The present invention also provides a use of a metrology system (100) as described above for dimensional verification of an object (200). The present invention also provides a method for dimensional acquisition of an object, comprising the steps of:
providing a light-projection device (110), LPD, configured to project an image (112) onto the object (200);
providing a position-measurement device (120), PMD, having a measurement volume, configured to determine the position and/or the orientation of the LPD (110) disposed within the measurement volume;
providing a dimensional acquisition device (140), DAD, that is an optical non-contact probe rigidly attached to the LPD configured to acquire dimensional data of the object (200);
moving the DAD (110) relative to the object (200) to acquire dimensions of the object (200);
adjusting the projected image (112) to have an essentially static appearance in relation to the object (200), which adjustment is responsive to movement of the LPD (110) detected by the position-measurement device (120), PMD,
conveying feedback information to the user responsive to dimensional acquisition by the DAD (140), via the image projected by the LPD (110).

The steps may be iterated in real-time.

The present invention also provides a computer program, or a computer program product directly loadable into the internal memory of a computer, or a computer program product stored on a computer readable medium, or a combination of such computer programs or computer program products, configured for adjusting a projected image (112) on an object, responsive to movement of the LPD (110) of a metrology system (100) as described above, or for performing a method as described above.

According to another aspect of the invention, there is provided a projection system comprising:
a light-projection device, LPD, configured to project an image onto an object;
a position-measurement device, PMD, configured to determine the position and/or the orientation of the LPD in relation to the object; and
an adjustment unit configured to adjust the projected image responsive to movement of the LPD detected by the position-measurement device, PMD.

In one embodiment of the invention, the adjustment unit further comprises:
a processing device, configured to receive signals from the PMD, process them and output signals to the LPD, preferably wherein the processing device is configured to control the position and/or orientation of the projected image on the object.

In another embodiment of the invention, the projected image is adjusted to have an essentially static appearance in relation to the object, responsive to movement of the LPD detected by the PMD.

In another embodiment of the invention, the projection system comprises a dimensional acquisition device, DAD, configured to acquire dimensional data of the object.

In another embodiment of the invention, the DAD is mechanically attached to the LPD.

In another embodiment of the invention, the processing device is further configured to:
receive dimensional data of the object from a dimensional acquisition device, DAD, configured to acquire dimensional data of the object; and
adjust the projected image responsive to the dimensional data of the object.

In another embodiment, the processing device is configured to:
receive a reference model, preferably a computer aided design, CAD, model, of the object;
receive data from the PMD as to the position and/or orientation of the LPD relative
adjust the projected image responsive to the data received from the PMD using the reference model to calculate the adjustment.

In another embodiment of the invention, the LPD is portable, preferably the LPD is handheld.

In another embodiment of the invention, the LPD projects the image along a projection beam, wherein the LPD is configured to allow spatial adjustment of the direction of the projection beam.

In another embodiment of the invention, the PMD is configured to determine the 6 degrees of freedom, 6DOF, related to the position and the orientation of the LPD or the PMD in relation to the object.

According to a second aspect, the invention encompasses a method for projecting an image onto an object with a projection system, preferably with a projection system according to the first aspect of the invention, comprising the steps of:
determining the position and/or orientation of an LPD relative to the object; and
adjusting the projected image responsive to the position and/or orientation of the LPD relative to the object.

In one embodiment of the invention, the position and/or orientation of the LPD relative to the object is detected by a position-measurement device, PMD.

In another embodiment of the invention, the method according to the second aspect of the invention comprises the steps of:
receiving dimensional data of the object from a dimensional acquisition device, DAD; and
adjusting the projected image responsive to the dimensional data.

In another embodiment of the invention, the steps are iterated in real-time.

According to a third aspect, the invention encompasses a computer program, or a computer program product directly loadable into the internal memory of a computer, or a computer program product stored on a computer readable medium, or a combination of such computer programs or computer program products, configured for adjusting a projected image on an object, responsive to movement of the LPD of a projection system according to the first aspect of the invention.

### BRIEF DESCRIPTION OF THE DRAWINGS

Embodiments of the present invention will now be described, by way of example only, with reference to the accompanying drawings, in which:

FIG. 1 depicts an illustration of a projection system 100 according to an embodiment of the invention.

FIGS. 2A and 2B depict an illustration of a light projection device 110 projecting a stable image 112 onto an object 200 before (solid lines) and after (dashed lines) movement of the light projection device 110 with respect to the object 200. In FIG. 2A, the static image 112 is maintained by adjusting the position of the image 112 within the beam area 115. In FIG. 2B, the static image 112 is maintained by adjusting the direction of the projected beam 114, and optionally by adjusting the shape of the image 112 to take into account the adjusted angle of direction of the projected beam 114 with respect to the object 200.

FIGS. 2C and 2D depict an illustration of a light projection device 110 projecting a stable image 112 onto an object 200 before (FIG. 2C) and after (FIG. 2D) translational movement of the light projection device 110 with respect to the object 200. In FIGS. 2C and 2D the static image 112 is maintained by adjusting the position of the image 112 within the beam area 115. The upper figures are three-dimensional schematic representations of the object and light projection device; the lower figures are side-profiles of the object and light projection device.

FIGS. 2E and 2F depict an illustration of a light projection device 110 projecting a stable image 112 onto an object 200 before (FIG. 2E) and after (FIG. 2F) rotational movement of the light projection device 110 with respect to the object 200. In FIGS. 2E and 2F the static image 112 is maintained by adjusting the position of the image 112 within the beam area 115, and optionally by adjusting the shape of the image 112 to take into account the adjusted angle of direction of the projected beam 114 with respect to the object 200. The upper figures are three-dimensional schematic representations of the object and light projection device; the lower figures are side-profiles of the object and light projection device.

FIGS. 2G and 2H depict an illustration of a light projection device 110 projecting a stable image 112 onto an object 200 before (FIG. 2G) and after (FIG. 2H) translational movement of the light projection device 110 with respect to the object 200. In FIGS. 2G and 2H the static image 112 is maintained by adjusting the direction of the projected beam 114, and optionally by adjusting the shape of the image 112 to take into account the adjusted angle of direction of the projected beam 114 with respect to the object 200. The upper figures are three-dimensional schematic representations of the object and light projection device; the lower figures are side-profiles of the object and light projection device.

FIGS. 2I and 2J depict an illustration of a light projection device 110 projecting a stable image 112 onto an object 200 before (FIG. 2I) and after (FIG. 2J) rotational movement of the light projection device 110 with respect to the object 200. In FIGS. 21 and 2J the static image 112 is maintained by adjusting the direction of the projected beam 114. The upper figures are three-dimensional schematic representations of the object and light projection device; the lower figures are side-profiles of the object and light projection device.

FIG. 3 and FIG. 4 depict a flow chart 500 illustrating the working principle of a processing device 131 of a projection system 100 according to embodiments of the invention.

FIG. 5 depicts a schematic overview of electronic connections according to an embodiment of the invention.

FIG. 6 depicts an alternative schematic overview of electronic connections according to an embodiment of the invention.

FIG. 7 depicts a schematic overview of the definitions of azimuth and elevation.

FIGS. 8A and 8B is a schematic illustration of a light projection device 110 containing a steerable mirror for adjusting the position of the projection beam. In FIG. 8B, the projection beam is steered downwards compared with FIG. 8A.

### DETAILED DESCRIPTION OF THE INVENTION

While the fixed projection systems in the art are much less expensive than hard templates, they are often limited to simple process information only. They may also require the use of an additional computer screen, which the operator needs to check regularly, distracting him from the task at hand. Furthermore, they may require high levels of training for the operator. Operation time may be slow, since the sheets need to be properly aligned before the task, and sometimes even re-aligned during the task. Due to the extensive set-up, the overall cost can still be relatively high. Moreover, such fixed projection systems are not suitable for objects with more complex geometries. More in particular, low visibility and shadow formation can be an issue.

The present invention aims to provide a projection system which solves one or more of the aforementioned disadvantages. Preferred embodiments of the present invention aim to provide a projection system which solves one or more of the aforementioned disadvantages. The present invention also aims to provide a method which solves one or more of the aforementioned disadvantages. Preferred embodiments of the present invention aim to provide a method which solves one or more of the aforementioned disadvantages.

To solve one or more of the above-described problems, at least one embodiment of the present invention adopts the following constructions as illustrated in the embodiments described below, which are illustrated by the drawings. However, parenthesized or emboldened reference numerals affixed to respective elements merely exemplify the elements by way of example, with which it is not intended to limit the respective elements.

Before the present system and method of the invention are described, it is to be understood that this invention is not limited to particular systems and methods or combinations described, since such systems and methods and combinations may, of course, vary. It is also to be understood that the terminology used herein is not intended to be limiting, since the scope of the present invention will be limited only by the appended claims.

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

The recitation of numerical ranges by endpoints includes all numbers and fractions subsumed within the respective ranges, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any 3, 4, 5, >6 or >7 etc. of said members, and up to all said members.

As used herein, the term “change in position” may also comprise a change in orientation. A change in position may be any translational change in (x,y,z) coordinates. A change in orientation may be any rotational change around any axis.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

In the following detailed description of the invention, reference is made to the accompanying drawings that form a part hereof, and in which are shown by way of illustration only of specific embodiments in which the invention may be practiced. It is to be understood that other embodiments may be utilised and structural or logical changes may be made without departing from the scope of the present invention. The following detailed description, therefore, is not to be taken in a limiting sense.

According to a first aspect of the present invention, there is provided a projection system 100 comprising:
a light-projection device 110, LPD, configured to project an image 112 onto an object 200;
a position-measurement device 120, PMD, configured to determine the position and/or the orientation of the LPD 110 relative to the object 200, and
an adjustment unit 130 configured to adjust the projected image 112 responsive to movement of the LPD 110 detected by the position-measurement device 120, PMD. In an embodiment, the adjustment unit 130 is comprised within the LPD 110.

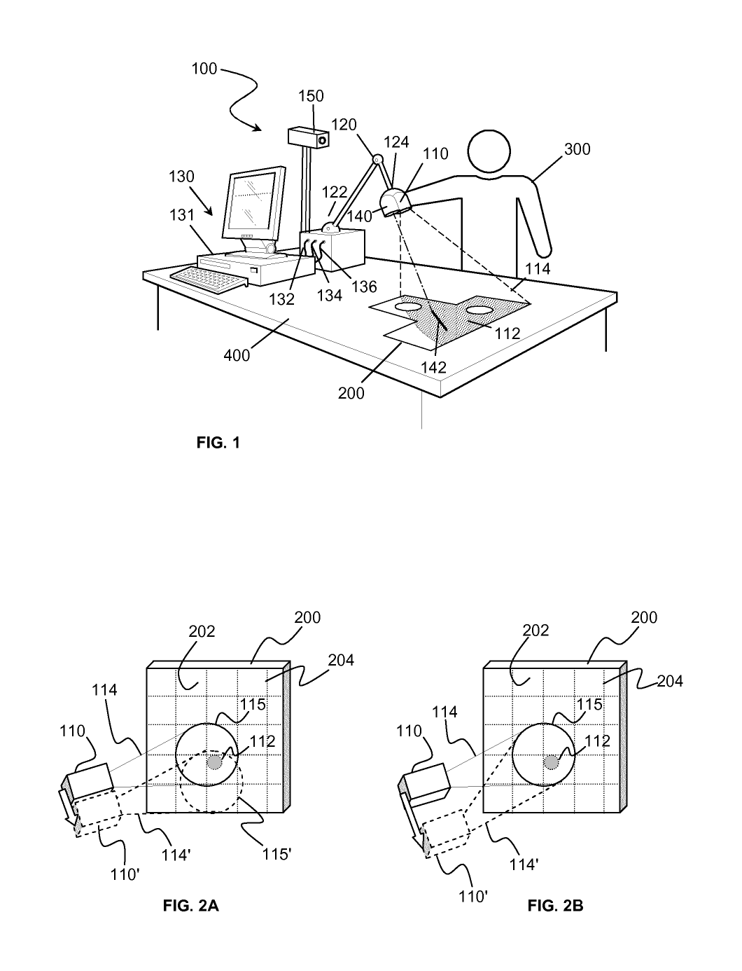

A system according to this embodiment will be described with reference to FIG. 1, which depicts an illustration of projection system 100 of an embodiment of the invention, together with an object 200 upon which an image 112 is projected, and together with an operator 300 who can manually manipulate the position and orientation of the LPD 110.

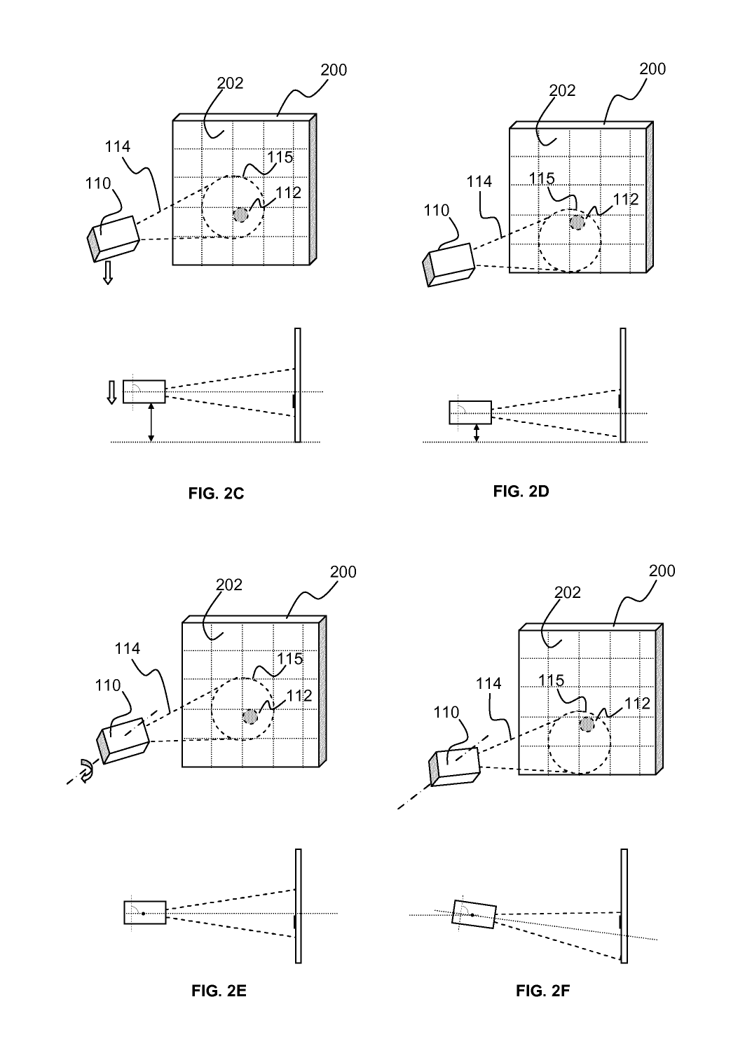

In a preferred embodiment, the projected image is adjusted to have an essentially static appearance in relation to the object, responsive to movement of the LPD relative to the object detected by the PMD. By essentially static, it is meant that the projected image position and optionally orientation essentially does not change relative to the object even when the LPD is moved relative to the object. For instance, should an operator move the LPD in a sweeping movement from left to right across the object, the projected image 112 will translate synchronously with the sweeping movement, but from right to left thereby giving the appearance that the projected image 112 is a static projection on the object. Preferably, the object 200 remains stationary while the LPD 110 moves. Systems according to this preferred embodiment will also be described with reference to FIGS. 2A to 2J.

Preferred embodiments of the present invention relate to a projection system 100 as shown, for instance, in FIGS. 2A and 2B comprising a light-projection device 110, LPD, configured to project an image 112 onto an object 200. Movements of the LPD 110 are measured using a position-measurement device 120, PMD, configured to determine the position and/or the orientation of the LPD 110 relative to the object 200. In FIGS. 2A and 2B, a starting position for the LPD 110, projection beam 114, and beam area 115 are shown using solid lines, while displaced positions for LPD 110′, projection beam 114′, and beam area 115′ (FIG. 2A only) are indicated using dashed lines.

FIGS. 2C, 2D, 2G and 2F illustrate the adjustments which may be made after translational movement of the LPD 110 with respect to the object 200. FIGS. 2C and 2D depict an illustration of a light projection device 110 projecting a stable image 112 onto an object 200 before (FIG. 2C) and after (FIG. 2D) translational movement of the light projection device 110 with respect to the object 200, and correspond to the translational movement of the LPD 110 and subsequent adjustments as shown in FIG. 2A. In FIGS. 2C and 2D the static image 112 is maintained by adjusting the position of the image 112 within the beam area 115.

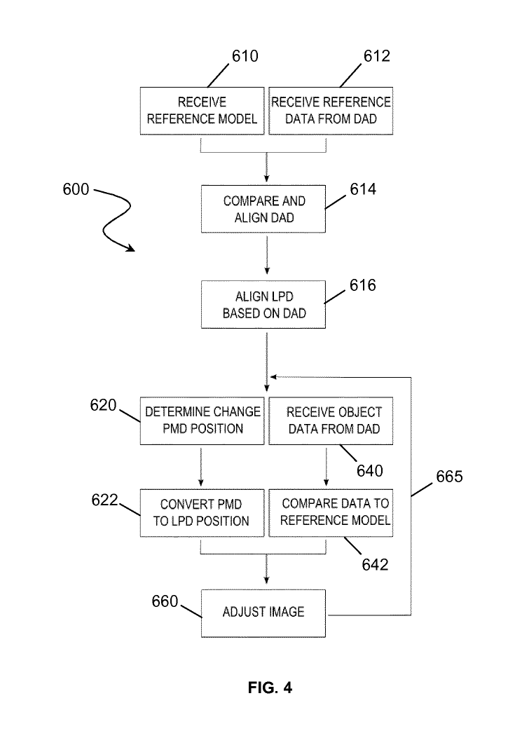

FIGS. 2G and 2H depict an illustration of a light projection device 110 projecting a stable image 112 onto an object 200 before (FIG. 2G) and after (FIG. 2H) translational movement of the light projection device 110 with respect to the object 200, and correspond to the translational movement of the LPD 110 and subsequent adjustments as shown in FIG. 2B. In FIGS. 2G and 2H the static image 112 is maintained by adjusting the direction of the projected beam 114, and optionally by adjusting the shape of the image 112 to take into account the adjusted angle of direction of the projected beam 114 with respect to the object 200. Adjusting the shape of the image 112 may be performed by modifying the image made by an imager (712 in FIG. 5) in the LPD 110.

FIGS. 2E, 2F, 2I and 2J illustrate the adjustments which may be made after rotational movement of the LPD 110 with respect to the object 200. FIGS. 2E and 2F depict an illustration of a light projection device 110 projecting a stable image 112 onto an object 200 before (FIG. 2E) and after (FIG. 2F) rotational movement of the light projection device 110 with respect to the object 200. In FIGS. 2E and 2F the static image 112 is maintained by adjusting the position of the image 112 within the beam area 115, and optionally by adjusting the shape of the image 112 to take into account the adjusted angle of direction of the projected beam 114 with respect to the object 200. FIGS. 2I and 2J depict an illustration of a light projection device 110 projecting a stable image 112 onto an object 200 before (FIG. 2I) and after (FIG. 2J) rotational movement of the light projection device 110 with respect to the object 200. In FIGS. 21 and 2J the static image 112 is maintained by adjusting the direction of the projected beam 114.

An adjustment unit 130 is preferably configured to maintain the position and/or orientation of the image 112 in fixed relation to the object 200 after movement of the LPD 110 by adjusting the projected image 112 responsive to movement of the LPD 110 relative to the object 200 detected by the position-measurement device 120. The adjustment may be to the position of the image 112 within the window of the beam area 115′ typically by applying a mathematical transformation to the image; it is appreciated that the direction of projection beam 114, 114′ can remain static with respect to the LPD 110 as shown in FIG. 2A. Alternatively, or in addition, the adjustment may be to the angular direction of the projected image 112 relative to the LPD 110 as shown in FIG. 2B; in such case, the projection beam 114′ and projected image 112 therein may be steered using, for instance, a steerable mirror or an adjustable mounting for a projector element within the LPD 110.

As used herein, the term “light-projection device” or LPD 110 comprises any device that is configured to emit a projection beam 114, thereby projecting an image 112 onto the surface of an object 200. The LPD typically comprises a light source together with an imager 712 such as a liquid crystal display (LCD) or digital micromirror device (DMD). The LPD 110 may be a liquid crystal display projector or a digital light processing (DLP) projector. In some embodiments, the projection system 100 comprises a plurality of LPDs 110. The LPD 110 may incorporate an adjustment unit 130, for example a mechanical adjustment unit 130 such as a controllably steerable mirror that can change the direction of projection of the projection beam 144 or image 112 from the LPD 110. The LPD 110 may also incorporate an electronic adjustment unit 130, such as a computer system, for example a personal computer, comprising a processing device 131, configured to change the image 112 from the LPD 110. In an embodiment, the adjustment unit 130 comprises both a mechanical adjustment unit and an electronic adjustment unit. The LPD 110 may be referred to as a ‘mobile light projection system’ (MLPS).

Preferably, the projected image 112 is an image of light. The projected image can be projected on an object 200, preferably on a target surface 202 of the object 200 as shown in FIG. 2. The projection may comprise a projection beam 114 that is essentially a cone of light. The projected image 112 is formed when the projection beam 114 is projected onto the object surface 202. The area 115 projected by the projection beam 114 on the object surface 202 is known as the beam area 115.

The image 112 may have an area that is smaller than the beam area 115 as shown in FIG. 2; this allows space within the bounds of the beam area 115 for movement of the image 112 over the object surface 202 while keeping the position of the projection beam 114 fixed as shown, for instance, in FIG. 2A. While the projection beam 114 may be fixed according to one aspect, it may alternatively or additionally be steerable as depicted in FIG. 2B. The projection beam 114 may be fixed or steerable in fixed relation to an internal chassis of the LPD 110.

In some embodiments, the projected image 112 may contain process information for user feedback for different kinds of industrial processes, thus replacing the need for a computer screen. By projecting the relevant user feedback information onto the area of the object 200 where it applies, the interpretation of the user feedback information may be greatly simplified. In a preferred embodiment, the projected image 112 comprises a laser template on a target surface of the object 200. The process information may be of several different types. In some embodiments, the projected image 112 comprises one or more items selected from the group comprising: maps, text, icons, work instructions, pointers, and reticles.

The projected image 112 may comprise one or more maps, preferably color coded maps. As used herein, the term “color coded map” refers to a color scheme that is projected onto a surface to indicate that the area that is illuminated to a specific color, is characterized by the value that matches the specific color. Color coded maps can be used to display the local accuracy of the surface geometry. A color coded map contains detailed information that may lead to a local rework of the object in order to get it within specifications of any sort (e.g. to get it within geometric tolerances by applying a grinding process locally on areas with excess of material). Color coded maps can also be used to display any other characteristic of an object, like internal stresses as a result of an FEA (finite element calculation). This could be used to improve the ease of interpretation of the user feedback towards the required improvement action.

Alternatively or in combination with the above, the projected image 112 may comprise text comprising user feedback for interpretation of a process step, for example display of local geometrical deviations, expressed in the appropriate measurement unit (such as mm, microns, inches). The text may also comprise warning messages or error messages. The text may also comprise instructions or work instructions for the operator 300 to carry out as part of a standard process or as a result of the real time process of the ongoing process step, for example to continue removing material at a specific indicated spot on the object 200.

Alternatively or in combination with the above, the projected image 112 may comprise icon-based information comprising user feedback or operator instructions, which may be projected in the shape of predefined images (e.g. an arrow, an exclamation mark, etc . . . ). The fact that an icon is projected and the location where it is projected on the object 200 may provide information to the operator 300. For example, an exclamation mark may indicate a problem with a real-time calculation, an arrow may indicate how to move a mobile device in order to find a next feature to investigate, and so on.

Alternatively or in combination with the above, the projected image 112 may comprise reticles (also referred to as reticules or cross hairs) for manual positioning of a tool. A projected cross hair may indicate the location of a manual operation to be carried out, such as the position to drill a hole or where to apply a rivet. Cross hairs can also be used for point-and-shoot indication of a specific location. For example, a cross hair could be used by the operator 300 to indicate a spot where a local reading needs to be expressed as a value. For example, the operator 300 may move the sensor until the cross hair coincides with a specific position on the object 200 and activates a function. In some embodiments, the LPD 110 may then project the XYZ deviations of the surface at the position of the cross hair by displaying a fly-out window with the X, Y, Z and/or normal deviations.

For complex object geometry, areas with difficult visibility may be more easily visualised by changing the alignment of the LPD 110. The projection of information onto the object 200 can eliminate the need to read that information from a computer screen. The optimal alignment can be performed automatically and/or intuitively, for example by re-positioning the LPD 110 and/or by pointing the LPD 110 to the concerned surfaces of the object.

The projection from the LPD 110 may comprise a projection beam 114, which is in fixed relation to the light-emitting end of the LPD 110 as shown in FIG. 2A. Alternatively or in addition, the angular direction of the projection beam 114 may be adjusted as shown in FIG. 2B. In a preferred embodiment of the invention, the LPD 110 projects the projected image 112 within a projection beam 114, and the LPD 110 is configured to allow spatial adjustment of the direction of the projection beam 114. For example, the adjustment unit 130 may steerably control a mirror incorporated into the LPD 110.

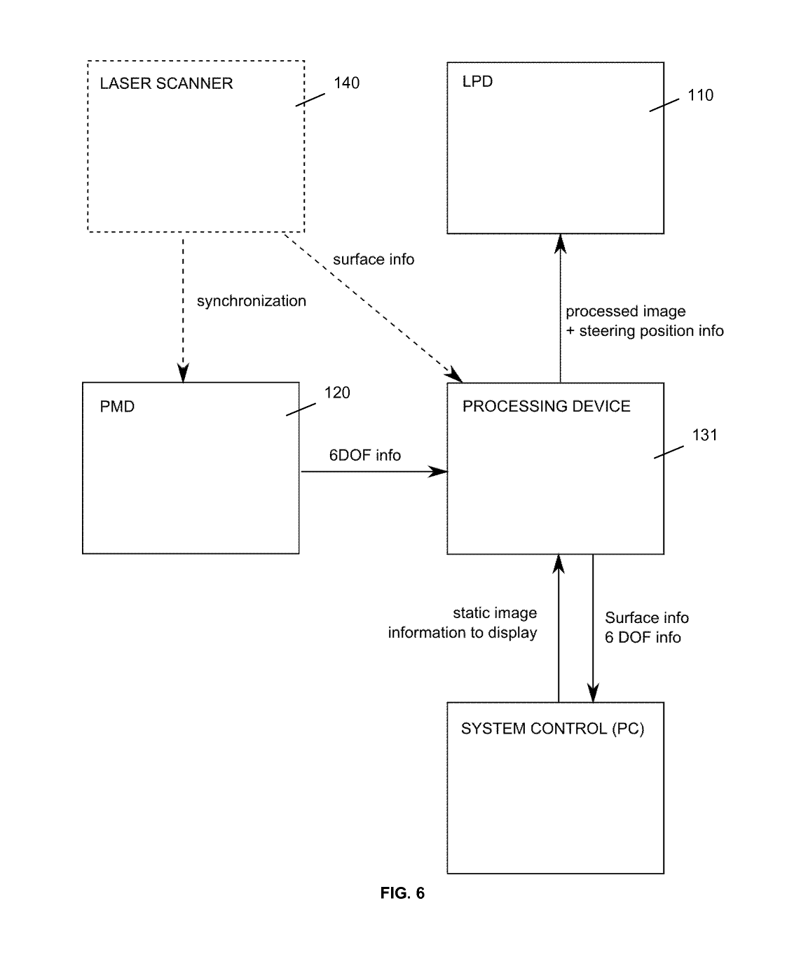

The direction 800 of the projection beam 114 may be represented as the azimuth (or azimuth angle) 810 and elevation (or elevation angle) 820 of the object 200. Azimuth 810 refers to the angular position of the object 200 relative to a vertical plane (projected perpendicularly onto a horizontal plane), while the elevation 820 refers to the angular position of the object 200 relative to a horizontal plane (projected perpendicularly onto a vertical plane), as illustrated in FIG. 7. The reference horizontal and vertical planes may be defined by the LPD 110 itself, or by the spatial relationship between the LPD 110 and the PMD 120.

In one embodiment of the invention, the projection system 100 further comprises:
the position-measurement device 120, PMD, configured to determine the position and/or the orientation of the LPD 110 or the PMD 120 in relation to the object 200.

The position-measurement device or PMD 120 is any device known in the art for measurement of the position and/or orientation of the LPD 110 in relation to the object 200. The PMD 120 typically has a measurement volume in which the LPD 110 is disposed. The LPD 110 is essentially observed by the PMD 120. The PMD 120 is typically external to the PMD 120. The LPD 110 may be mechanically connected to the PMD 120; such PMD 120 typically has a base end 122 and an effector end 124 connected by one or more interconnected moveable members. The base end 122 of the PMD and an object 200 can be mounted on a solid surface 400 such that there is no relative movement during projection. The effector end of the PMD 120 may be provided with a coupling for dismountable attachment to the LPD 110 and optionally to a dimensional acquisition device. The LPD 110 is preferably mechanically attached to the effector end 124. The mechanical attachment is preferably rigid. The position of the effector end and hence of the LPD 110 may be determined from angles and/or displacements arising between the moveable members, while the LPD 110 is moved. The moveable members may be arranged in a kinematic chain having rotary encoders at each joint, for instance. Examples of such a PMD 120 include an articulated arm, a localizer, a coordinate measuring machine (CMM), or a coordinate measuring arm (CMMA) 121. The PMD 120 may be robot, such as a robot coordinate measuring arm (Robot CMMA) as described, for instance, in WO 2004/096502.

Alternatively, the PMD 120 may comprise an overseeing device 150, such as a camera, configured to optically track the LPD 110; the LPD 110 may be disposed with one or more reflective or light-emitting markers which are detected by the camera 150, from which the position and/or orientation of the LPD 110 can be determined. Tracking of the position and/or orientation of an object by an overseeing device 150, such as a camera, is known in the art, for instance from WO 98/36381 and WO 03/067546. Such a camera 150 is typically provided with a lens that focuses light onto a two dimensional active pixel sensor (e.g. a CMOS or CCD sensor) for capture of the image of the LPD 110 or reflective or light-emitting markers thereon. The camera 150 is typically disposed in fixed relation to the object 200 and arranged so that the LPD 110 remains within the field of vision for the range of its movements. The position in space of the LPD 100 may be determined from its position the within the captured frame or on the active pixel sensor.

Information as to the orientation of the LPD 110 may be obtained when there are three or more markers on the LPD 110, and the distances between the markers are known. The positions of said markers may be measured in two dimensions by means of the camera 150. In particular, the co-ordinates of the position of each of the markers may be determined according to two preferably perpendicular directions in a plane standing at right angles to the optical axis of the camera 150. Next, the actual three-dimensional position of the markers is calculated on the basis of the positions of the markers, thus measured in a two-dimensional manner, and the real distance between each of these markers. In the case of a two-dimensional position measurement, one measures the position of said markers in a plane standing at right angles to the optical axis of the camera 150. By taking into account, however, that these markers have a fixed position in relation to one another, the co-ordinate of each of the markers is calculated on the basis of the real spatial distances between these markers and their co-ordinates measured in a two-dimensional manner, according to the direction of the optical axis of the camera 150. This calculation is made according to conventional goniometric calculation methods. Examples of such a PMD 120 includes an optical tracker, a laser tracker probe, a K-series camera (manufactured by NikonMetrology), and an iSpace system (manufactured by NikonMetrology). In some embodiments, the PMD 120 comprises a local inertial system, such as an accelerometer or a gyroscope.

As mentioned earlier, the PMD 120 is configured to determine the position and/or the orientation of the LPD 110 in relation to the object 200. Preferably, the PMD 120 is configured for measuring all 6 degrees of freedom (DOF), for example 3 DOF for position and 3 DOF for orientation, also referred to as 6DOF, of the LPD 110 in relation to the object 200 In a preferred embodiment of the invention, the PMD 120 is configured to determine the 6 degrees of freedom, 6DOF, related to the position and the orientation of the LPD 110 in relation to the object 200.

As mentioned earlier, the adjustment unit 130 is configured to maintain the projected image 112 essentially static relative to the object by mathematically transforming the image and/or by steering the projection beam 114. The adjustment unit 130 according to the invention may comprise mechanical components, optical components, electronic components (such as a processing device 131), or a combination thereof. The adjustment unit 130 may be incorporated partially or entirely into the LPD 110.

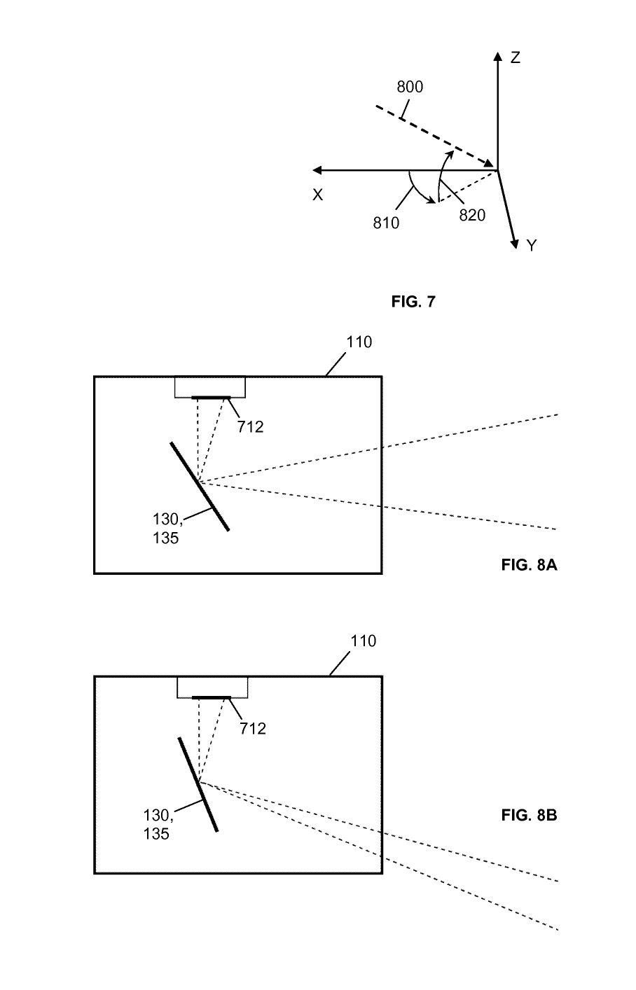

In an embodiment, the adjustment unit 130 comprises one or more mechanical and/or optical components, optionally comprising one or more steering mechanisms. A non-limiting example of such an adjustment unit 130 comprises a steerable mirror. FIGS. 8A and 8B illustrate an LPD 110 wherein the adjustment unit 130 comprises a steerable mirror 135. In FIG. 8B, the orientation of the mirror 135 is adjusted to displace the projected image downwards compared with FIG. 8A. The adjustment unit 130 may comprise one or more mechanical components, preferably one or more joints, such as a universal joint, ball joint, or a gimbal. The adjustment unit 130 may comprise one or more steering mechanisms, such as a servo, a linear motor, or a magnetic steering mechanism. The adjustment unit 130 may comprise one or more optical components, such as mirrors, lenses, prisms.

In an embodiment, the adjustment unit 130 comprises a processing device 131, configured to receive signals from the PMD 120, process them and output signals to the LPD 110, preferably wherein the processing device 131 is configured to control the position of the projected image 112 on the object 200. The processing device 131 may perform transformations to the image, or may steer mechanical and/or optical components, or may perform a combination of both.

In an embodiment, the processing device 131 may use mathematical models to transform the position and/or shape of the image 112. The processing device 131 may also comprise mathematical models to transform the shape of the projected image 112. In an embodiment, the adjustment unit 130 also comprises a mechanical steering element, steered by the processing device 131. The adjustment of the image 112 may be performed electronically (i.e. by transformation of the image), mechanically/optically, or through a combination of both.

As mentioned earlier the projected image 112 may be projected within a static projection beam 114, in which case the image area 112 relative to the beam area 115 is small. That the image area 112 is smaller than the beam area 115 allows a window for movement of the projected image 112 within the bounds of the projected beam area 115 without the need to steer the projected beam. In such cases, the processing device 131 may use one or more mathematical models to transform the position and/or shape of the image 112.

The signals from the PMD 120 may specify a transform R_po (position and rotation) with reference to the object 200. The image 112 on the object may be described by a transform R_io (position and rotation) with reference to the object 200. The image 112 on the object 200 is formed by the projection on the object 200, which is influenced by the transform R_po, and the image changes transform R_im (position, rotation, scaling, deformation) in the LPD 110. To maintain the image 112 stable on the object 200, the image R_im is adapted to compensate for the change in R_po, which can be performed by matrix manipulations and matrix calculations.

The projection on the object 200 can be described by matrices. If the object 200 is non-flat, this may also be described by functions. In all cases, it may be assumed that the observer view point (user) is near the LPD 110. If the observer view point is at a significantly different location, an extra deformation transform may be added to account for the new perspective by the observer.

For example, the processing device 131 may perform the following steps:
calculating the image to be seen by observer, based on R_io;
calculating the transformed image needed on the object 200, using the observer R_obs (position and rotation relative to the object 200), wherein this calculating step may involve scaling, rotation, deformation, preferably wherein R_obs is identical or almost identical to R_po;
optionally, for a non-flat object 200, adapting the image to compensate for the curvature of the surface of the object 200, wherein for simple deformations this step may be performed through functions, and wherein for more complex deformations, this step may be performed through ray tracing; and
from the image on the object, calculating the image in the LPD using the inverse of R_po.

Alternatively or additionally, the projected image 112 may be moved using a steerable projection beam 114. The image area 112 may be smaller or the same size as the beam area 115. Movement of the projected image 112 relative to the object surface 202 to maintain a static appearance is achieved by steering the projection beam 114 (e.g. FIG. 2B) and/or by moving the projected image 112 within the bounds of the projected beam area 115 (e.g. FIG. 2A). In case of such mechanical steering element, such as a steerable mirror, a new transform R_mirror may add extra flexibility. The same steps and matrix equations as discussed above may be used, but with an extra transform. In a preferred embodiment, the correction can be performed by moving the image as described above for high frequency movements (with small amplitude), while low frequency adaptations (with larger amplitude) are performed with additional use of a steerable mirror (R_mirror).

Preferably, the processing device 131 tries to keep the image in the middle of the LPD 110, by adapting the mirror position.

As mentioned earlier, the projected image 112 may be adjusted so that the image 112 has an essentially static appearance in relation to the object 200, responsive to movement of the LPD 110 detected by the PMD 120. In such an embodiment, the projected image 112 remains (essentially) stable on the object 200, even if the LPD 110 is (constantly) moving. Adjustment of the projected image 112 may comprise adjustment of the position of the projected image 112 and/or adjustment of the orientation of the projected image 112. Adjustment of the image may comprise one or more of translating, rotating, tilting, resizing and skewing the projected image 112.

In an embodiment, the projected image 112 is adjusted to compensate for the deformation of the projected image 112 by a curved (non-flat) surface of the object 200.

In an embodiment, the projected image 112 is adjusted using ray tracing (using the reverse light path) from the desired image on the object 200, back to the LPD 110. The desired image in the LPD 110 is what would be seem by a camera (image sensor) at the same place as the LPD 110, when the desired image would be the object 200. Such a ray tracing technique may be performed by commercially available software compiled in an adjustment unit 130 comprising a processing device 131. If the position and orientation of the observer and LPD 110 are substantially different, a correction may be applied, based on the difference between location and orientation between observer and LPD. Depending on the actual object 200 and geometrics, ray tracing may not always be possible, for example due to occlusion of certain parts of the object 200.

The object 200 may be fixed relative to the measurement reference frame of the PMD 120 during projection, for example on a surface 400. Alternatively, the object 200 may not be fixed relative to the measurement reference frame of the PMD 120 during projection. An overseeing device that observes both the object 200 and the PMD 120 or a point in fixed relation to the PMD may then provide information on the movement of the object 200 relative to the PMD 120. The overseeing device 150 may comprise a camera configured to optically track the object 200 relative to the PMD 120. For example, the object 200 and optionally the PMD 120 may be disposed with one or more reflective or light-emitting markers which are detected by the camera 150, from which the position and orientation of the object 200 can be determined.

The projection system 100 according to the invention may be used to project an image 112 onto a specific area of an object 200, or onto a specific area of a target surface of an object 200. The PMD 120 is configured to determine the orientation of the LPD 110 in relation to the object 200. Preferably, the projection system 100 uses data obtained from the PMD 120 to derive the relative position and/or orientation of the LPD 110 with respect to the object 200. This data may be used to adjust the projected image 112 to provide a stable image 112 projected on the corresponding surface area of the object 200 during movement of the LPD 110.

If the position and/or orientation of the PMD 120 relative to the LPD 110 is known, or can be determined, then the position of the LPD 110 in relation to the object can be determined from the position of the PMD 120 in relation to the object. In a preferred embodiment, the PMD 120 is mechanically attached to LPD 110. The position and/or orientation of the LPD 110 relative to the object 200 can then be easily derived from the position and/or orientation of the PMD 120 relative to the object 200.

In a preferred embodiment, the PMD 120 and LPD 110 are mechanically connected, preferably rigidly mechanically connected, preferably at the effector end 124 of the PMD 120. In such an embodiment, the relation (or calibration) between the PMD 120 and LPD 110 may be readily determined and set for at least part of the lifetime of the system without need for further calibration. The calibration may be set at the factory. Once the calibration is known, it does not need to be re-calculated for each use; however, it will be appreciated that a calibration may be performed periodically e.g. on a monthly or yearly basis as required.

In a preferred embodiment of the invention, the projection system 100 further comprises a dimensional acquisition device 140, DAD. Preferably, the DAD 140 is configured to acquire dimensional data of the object 200. Such a system 100 incorporating a DAD 140 is more typically known as a metrology system, insofar as it is employed to produce a stream of data relating to the dimensions of an object.

As used herein, the term “dimensional acquisition device” or DAD 140 comprises any device that is configured to acquire dimensional data of the object 200, preferably 3D dimensional data of the object 200. The DAD typically outputs data signals that may be electronic or optical. For example, the DAD 140 may comprise a metrology receiver. In some embodiments, the DAD 140 comprises a plurality of metrology receivers. Examples of DADs 140 include a non-contact probe, an optical non-contact probe, a laser scanner, a laser profiler, a contact probe, and the like.

In an embodiment, the DAD 140 is mechanically attached to the LPD 110. Preferably, the DAD 140 is rigidly mechanically attached to the LPD 110. Preferably this mechanical attachment provides a fixed relation between the DAD 140 and the LPD 110. In an embodiment, the DAD 140 is mechanically attached to the PMD 120, preferably to the effector end 124 of the PMD 120. In a preferred embodiment, both the DAD 140 and the LPD 110 are mechanically attached to the effector end 124 of the PMD 120. In an embodiment, the PMD 120 is configured to determine the orientation of the DAD 140 in relation to the object. FIG. 1 depicts an embodiment wherein the DAD 140 and the LPD 110 are mechanically attached to the PMD 120, but wherein the DAD 140 and the LPD 110 are movable in relation to the object 200.

In an embodiment, the DAD 140 and LPD 110 are two separate units, and are configured to minimize perturbation of the DAD 140 by the projected image 112. For example, when the DAD 140 is a Laser Scanner, it may be set to project a specific light color and may comprise specific light filters to prevent the projected image 112 from influencing the data acquisition via a light stripe 142. In another example, the LPD 110 and DAD 140 may be synchronized such that during each flash of a Laser Scanner, no image is projected.

The DAD 140 may be used to align the projection system 100 with the object 200. The DAD 140 may additionally or alternatively be used to acquire dimensional data of the object 200 simultaneously with projecting an image 112 onto the object 200. In an embodiment, the LPD 110 is synchronized with a laser scanner DAD 140. The LPD 110 projects as part of the image a line such as a line stripe projector. The image projected by the LPD 110 may convey feedback information to the user responsive to dimensional acquisition by the DAD 140.

FIG. 5 depicts a chart showing the relationships between a DAD 140, an LPD 110, a PMD 120 (comprising a CMMA 121) and a processing device 131 and signals that may be sent between them. The DAD 140 in FIG. 5 may be a Laser Scanner 740, comprising a light detector 742 and a laser source 744. The LPD may comprise a steering mechanism 710 connected to a light source 714 and an imager 712. The processing device 131 may be located in a number of places. In an embodiment, the processing device 131 is in a separate box (for example a PC), for example through a wired or wireless connection. In a preferred embodiment the processing device 131 is located in or near the LPD 110, and preferably communicates through wireless signals. Sending 6DOF to the LPD 110 needs much less bandwidth than sending a video stream. In an embodiment, the mainly static part of the image (before motion related processing) is controlled by a PC. The processing device 131 may comprise a DSP controller 730 which may control a field-programmable array (FPGA) 732 and/or a peripheral interface 734, for example a serial peripheral interface bus (SPI). The processing device 131 which may communicate through Bluetooth 731, WiFi 733 and/or a connector 735.

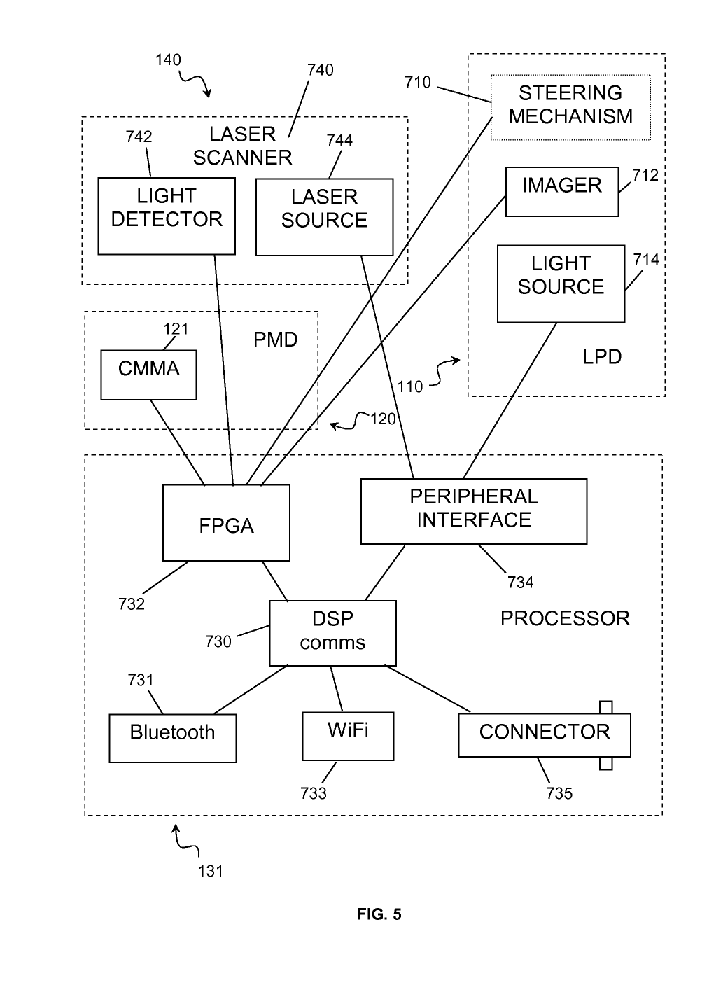

FIG. 6 shows the information that may be transferred between several components. An optional DAD 140 (in this case a laser scanner) may transmit surface information to a processing device 131, which forms part of an adjustment unit 130 (in this case a PC). The DAD 140 may have an internal CPU and FPGA to generate the surface info. The DAD 140 may also provide synchronization to a PMD 120. The PMD 120 may comprise its own electronics, possibly including an FPGA. The PMD 120 provides position location information, such as 6DOF to the processing device 131. The processing device 131 may have its own electronics to perform image processing and communication. The image processing may be FPGA, DSP or GPU based, or based on a combination thereof. The processing device 131 may then send a processed image, steering position info, or a combination thereof to an LPD 110. The LPD 110 may have its own electronics to control the steering (for example through a steerable mirror) if present and to control the imager.

In order to take the position of the object 200 with respect to the projection device 100 into account, an alignment procedure is preferably carried out, prior to the actual projection functions. Alignment procedures are known in the art, and may comprise the use of a DAD 140, such as tactile measurement, scanning and best fit of the object 200, and/or scanning and best fit of any type of reference features that are connected to the object 200. Preferably, a projected image 112 is generated that takes into account the line of sight restrictions of the visibility of the surface of the object 200 from that specific position.

In some embodiments, the DAD 140 comprises one or more probes. The probes may be any kind of probe, such as a non-contact probe, for example a light probe configured for emitting a light stripe 142, or a contact probe, for example that utilizes a tactile member. The probe can be configured to capture probe data, preferably dimensional data of the object. Preferably, the probe data that contains dimensional data of the object may be used to adjust the projected image 112, for example by the processing device 131.

Types of non-contact probe include a scanner, preferably a laser scanner. Suitable laser scanners are commercially available from e.g. Nikon Metrology NV, Faro Technologies Inc, and Perceptron Inc. The probe may be provided with a coupling member configured for attachment to a robot or utilized for hand-held, manual data acquisition.

Alternatively, the probe may be a radiation meter, temperature probe, thickness probe, light-measurement probe, or profile measuring probe. The thickness probe may employ ultrasound, or ionizing radiation.

The type feedback information provided by the projected image can vary; some examples follow. The dimensional data of the object 200 may comprise information on the shape and/or curvature of a target surface of the object 200. The target surface may be an essentially flat surface or a curved surface. In some embodiments, the dimensional data of the object 200 comprises information on displacement of the target surface of the object 200. In some embodiments, the dimensional data of the object 200 comprises information on stress on the target surface of the object 200.

In some embodiments, the DAD 140 is configured to create a surface representation of the object 200. Non-limiting examples of suitable surface representations include a set of points, a point cloud, a set of triangles (triangle mesh), and a set of polygons (a polygon mesh).

In a preferred embodiment of the invention, the projection system 100 is configured to adjust the appearance of the projected image 112 responsive to the dimensional data of the object 200.

In some embodiments, a reference model is available of the object 200. For example, in an inspection application, this reference model can comprise a computer-aided design, CAD, model of the object 200. In an embodiment, the geometrical deviations between (the surface of) the object 200 and the reference model, preferably a CAD model, can be derived from the data acquired by the DAD 140. Preferably, these deviations are subsequently displayed onto the object 200 by the LPD 110, for example as a color coded pattern. Surface deviations can also be displayed as magnified color coded vectors. In an embodiment, such a pattern is generated based on a comparison of the measured point cloud to the nominal surface of the object 200. The deviations can be projected onto the object 200 during and/or after the measurement by the DAD 140 takes place.

The projection system 100 comprising a DAD 140 can also be used for dimensional verification of geometrical features of the object 200, for example round holes, slot holes, edges, and fixture elements. In an embodiment, the deviations of such geometrical features are calculated and displayed as textual values, for example shown in fly-out windows that point to the concerning area on the object 200.

In an embodiment, the representation of deviations of the geometry of an object 200 enables the operator 300 to conclude on the required additional process steps, if any, to get the product within its desired specifications. This can be obtained by modifying the product itself or by modifying the process parameters in a manufacturing facility.

In some embodiments, the projected image 112 identifies the surface area of the object 200 that has already been scanned by the DAD 140. In a preferred embodiment, the projected image 112 indicates the quality (e.g. local quality) of the scan by the DAD 140. In some embodiments, for example when the DAD 140 comprises a manual laser scanner, the point coverage during the scanning can be projected by the LPD 110 in order to guide the operator 300 to areas where the point density is not yet sufficient. In a preferred embodiment, the projected image 112 indicates the quality of the scan by the DAD 140 and provides instructions to the user.

In preferred embodiment of the invention, the processing device 131 is further configured to:
receive dimensional data of the object 200 from a dimensional acquisition device 140, DAD, configured to acquire dimensional data of the object 200; and
adjust the projected image 112 responsive to the dimensional data of the object 200.

Alignment of the projection system 100 with the object 200 can be performed in several ways, depending on whether the projection system comprises a DAD 140 and/or a utilises a reference model of the object 200. The reference model is a mathematic representation of the object 200 (e.g. a computer-aided design model of the object). Some possible different configurations are discussed below.

In an embodiment, the projection system 100 comprises an LPD 110 and a PMD 120, but does not utilise a reference model and does not use a DAD 140. The system can be programmed to present information (in one or more information zones) to the user based on the LPD 110 position as given by the PMD 120. The PMD 120 may mainly be used for position determination. The positions of the information zones can be fixed, or can be dependent on the actions of the user. For example, the user can indicate the four corners of the work zone, similar to touch screen calibration. The LPD 110 could project for example a cross-hair, and the user would point to each calibration point and push a button to calibrate.

In an embodiment, the projected image 112 comprises information for the user, such as instructions. The instructions may be updated as the LPD 110 is moved.

In an embodiment, the projection system 100 comprises an LPD 110, a PMD 120, and utilises a reference model, but no DAD 140. To correlate the reference model with the position of the object 200, the user can be instructed by simple instructions projected by the LPD 110 to aim the LPD 110 at specific points of the object 200. For example, a crosshair or a part of the reference model may be projected, which is the user then aligns with the actual object 200; once they are aligned, the user may confirm by pressing a trigger. The number of calibration points may depend on the required accuracy.

In an embodiment, the projection system 100 comprises an LPD 110, a PMD 120, and a DAD 140, but does not utilise a reference model. Without a reference model, the user preferably scans enough of the object to provide an internal representation of the object 200. This internal representation can then be used similarly to the reference model for image correction. The quality of image projection may gradually improve as more information of the object 200 is acquired through the DAD 140.

In an embodiment, the projection system 100 comprises an LPD 110, a PMD 120, and a DAD 140, and a reference model. The process for alignment is similar to the case as described for the situation without a DAD 140, but the DAD 140 can now be used as a higher performance calibration device, thereby improving the accuracy of alignment, independent from the user's ability to align a crosshair or image with the object 200. Using the DAD 140 to measure a few parts of the object, provides the possibility to align the reference model and to immediately improve image projection quality for the full object 200, and not only the parts that have already been scanned. In addition, the reference model can be used to calculate differences between the actual object 200 and the reference model and show these in the projected image 112.

In an embodiment, the processing device 131 is configured to:
receive data from the PMD 120 as to the position and/or orientation of the LPD 110 relative to the object 200;
optionally, receive dimensional data acquired from a DAD 140;
optionally, receive a reference model, preferably a computer aided design, CAD, model, of the object 200;
adjust the projected image of the LPD 110 responsive to the data received from the PMD 120, optionally also responsive to the data received from the DAD 140, optionally also using the reference model to calculate the adjustment.

In another embodiment, the processing device 131 is configured to:
receive a reference model, preferably a computer aided design, CAD, model, of the object 200;
receive data from the PMD 120 as to the position and/or orientation of the LPD 110 relative to the object 200; and
adjust the projected image responsive to the data received from the PMD 120 using the reference model to calculate the adjustment.

In some embodiments, the adjustment by the processing device 131 uses an inspection program. In a preferred embodiment, this inspection program is linked to a DAD 140. An example of an inspection program suitable for the invention is Focus Inspection, commercially available by Nikon Metrology.

The processing device 131 may be provided as a single unit, or a plurality of units operatively interconnected but spatially separated. The processing device 131 may be integrated fully or partly into the housing of the PMD 120 or into a single housing that contains both the PMD 120 and LPD 110. Where there is partial integration, it is meant a separate unit outside the housing may contain part of the electronics of the processing device 131. Alternatively, the processing device 131 can be housed fully outside the housing of the PMD 120 and LPD 110 or outside the single housing that contains both the PMD 120 and LPD 110 (e.g. as a dedicated processing unit, as a laptop, desktop computer, smartphone, tablet device). When the processing device 131 is housed fully outside or is only partly integrated, interconnections between devices may utilize a cable or wireless connection (e.g. Bluetooth, Wifi, ZigBee or other standard). Different connections 132, 134 and/or 136, may be used for connecting the processing device 131 with the LPD 110, the PMD 120 and/or the DAD 140 respectively. It will be appreciated that the sub-processors and/or processing device 131 may also perform other tasks such as synchronization, system control, power management, I/O communication and the like typically associated with digital systems. The processing device 131 may also operate with other devices (both hardware and software). The processing device 131 may also perform adjustments of and/or transformations to the projected image 112, for example to rotate, translate, tilt, skew or re-size the projected image 112.

In an embodiment, the processing device 131 comprises one or more specific functionalities. These functionalities may be triggered by pointing the LPD 110 to a specific area (this may be somewhat similar to a traditional computer mouse pointing a cursor to a specific area of the computer screen). For example, pointing the LPD 110 to a region of the workspace, may activate a display of the status, or may activate a help display, or may activate a the display of a set of instructions.

One or more elements of the projection system 100, for example the LPD 110, the PMD 120, the processing device 131 and/or the DAD 140 may be provided in a plurality of separate housings, or preferably may be integrated into a single housing. A single housing offers convenience of portability and size. Additionally, the housing or an internal chassis therein may provide a rigid fixture for the LPD 110 and the PMD 120, optionally also for the DAD 140, to hold them in a fixed relative spatial alignment for optimal performance. In a preferred embodiment of the invention, the LPD 110 is portable, preferably the LPD 110 is handheld.

For specific user interface functionality a trigger button and one or several function buttons may be required to activate and trigger specific functions (e.g. the indication of a spot to generate a text window with the deviations in that indicated spot).

The projection system 100 according to the first aspect of the invention and preferred embodiments thereof provide one or more of the following advantages:
the possibility to display complex process information, which may be difficult to interpret from a computer screen;
elimination of the requirement of a computer screen or the requirement to have constant visibility of a computer screen for process feedback;
reduction of operator 300 training requirement when interpretation of process steps is simplified;
reduction of operator 300 training requirement when each process step can be displayed sequentially for operator 300 guidance, eliminating the need to memorize all process steps;
gain in operation time through constant focus of the operator 300 onto the object 200 without the need to move to or glance at a computer to interpret the information displayed on the computer screen;
gain in operation time through an increase of process speed by the projection of operator instructions to perform the manual process, together with the indication of which area these instructions related to;
quality improvement through a simplification of the process feedback display enables the interpretation of the info, suitable to a large group of lower skilled operators;
quality improvement through reduction of the risk of process steps being skipped or performed in wrong order;
cost reduction through reduction of the number of iterations involved in the process to reach a certain quality level;
ability to display information on objects with complex geometry; and/or
elimination or reduction of shadow formation.

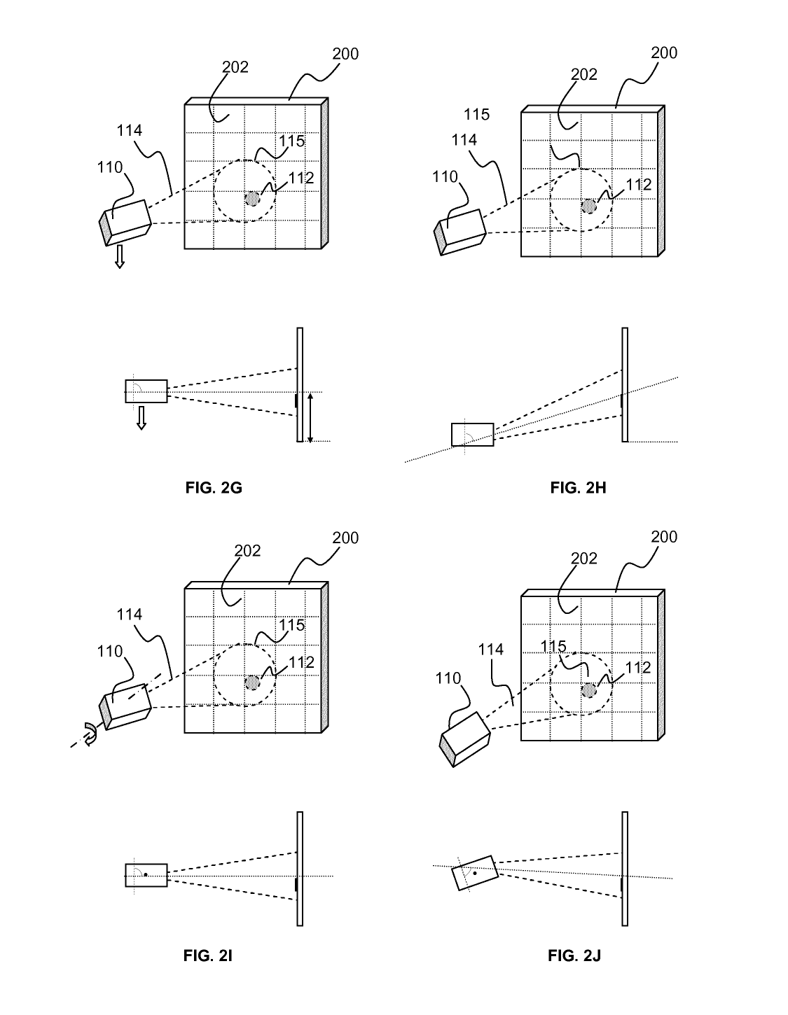

An exemplary operation 500 of an adjustment unit 130 comprising a processing device 131, as part of the projection system 100, is described below with reference to the flowchart of FIG. 3.
1) In a first stage 510, the LPD 110 is aligned with the object 200 to obtain a starting point.
2) In a second stage 520, a change in LPD 110 position and optionally orientation is measured using the PMD 120.
3) In a third stage 560, the projected image 112 is adjusted based on the change in LPD 110 position and optionally orientation measured in the second stage.

The second stage and the third stage may then be iterated 565, preferably in real-time.

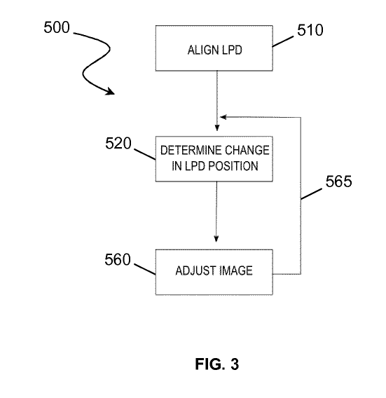

An exemplary operation 600 of a processing device 131, as part of the projection system 100 comprising a DAD 140, is described below with reference to the flowchart of FIG. 4.
1) In a first stage, the DAD 140 is deployed to measured the object 200. This first stage may comprise the following steps:
   receiving 610 a reference model, such as a CAD model, of the object 200;
   receiving 612 acquisition data from the DAD 140 concerning the object;
   comparing 614 the acquisition data to the reference model to determine the spatial relationship between the DAD 140 and the object 200; and
   using the spatial relationship between DAD 140 and LPD 110 to determine the spatial relationship between 616 the LPD 110 and the object

The step of determining the spatial relationship between the DAD 140 and the object 200 assists in an initial set-up of the system 100. In this embodiment, the DAD 140 is used to measure the object 200, while the PMD 120 is used to measure the LPD 110. The presence of a DAD 140 is particularly preferred if no correct model of the object 200 is available.
2) In a second stage, any change in LPD 110 position and optionally orientation is measured by the PMD 120. This second stage may comprise the following steps:
   receiving 620 measurement information from the PMD 120 concerning the position and optionally orientation of the LPD; and
   using the spatial relationship between PMD 120 and LPD 110 to convert 622 the measurement information from the PMD 120 information as to the spatial relation between the to a change in LPD 110 position.
Parallel to this second stage, the DAD 140 may optionally acquire dimensional data on the object 200 This optional stage may comprise the following steps:
   receiving 640 dimensional data of object 200 from DAD 140; and
   comparing 642 the dimensional data with the reference data received in the first stage.
3) In a third stage, the projected image 112 is adjusted 660 based on the change in LPD 110 position obtained in the second stage, and optionally based on the comparison between dimensional data and reference data as obtained in the optional stage.

The second stage, the optional stage, and the third stage may then be iterated 665 in real-time.

According to a second aspect, the invention encompasses a method for projecting an image 112 onto an object 200 with a projection system 100, comprising the steps of:
determining the position and/or orientation of an LPD 110 relative to the object 200; and
adjusting the projected image 112 responsive to the position and/or orientation of the LPD 110 relative to the object 200.

Preferably the projection system 100 is a projection system 100 according to the first aspect of the invention.

In one embodiment of the invention, the position and/or orientation of the LPD 110 relative to the object 200 is detected by a position-measurement device 120, PMD.

In another embodiment of the invention, the method according to the second aspect of the invention comprises the steps of:
receiving dimensional data of the object 200 from a dimensional acquisition device 140, DAD; and
adjusting the projected image 112 responsive to the dimensional data.

Preferably, the PMD 120 determines the position and/or orientation of the LPD 110 relative to the object 200 in real-time. Such a PMD 120 may be referred to as a ‘real-time positional tracker’ (RTPT). In a preferred embodiment of the invention, the steps are iterated in real-time.

According to a third aspect, the invention encompasses a computer program, or a computer program product directly loadable into the internal memory of a computer, or a computer program product stored on a computer readable medium, or a combination of such computer programs or computer program products, configured for adjusting a projected image 112 on an object, responsive to movement of the LPD 110 of a projection system 100 according to the first aspect of the invention.

The invention also encompasses a computer program, or a computer program product directly loadable into the internal memory of a computer, or a computer program product stored on a computer readable medium, or a combination of such computer programs or computer program products, for providing the position and/or the orientation of the LPD 110 in relation to the object 200 of a projection system 100 according to the first aspect of the invention.

The invention also encompasses a computer program, or a computer program product directly loadable into the internal memory of a computer, or a computer program product stored on a computer readable medium, or a combination of such computer programs or computer program products, for providing and/or processing the position and/or the orientation of the LPD 110 in relation to the object 200 of a projection system 100 according to the first aspect of the invention.

The invention also encompasses a computer program, or a computer program product directly loadable into the internal memory of a computer, or a computer program product stored on a computer readable medium, or a combination of such computer programs or computer program products, for providing and/or processing dimensional data of the object 200 acquired by the DAD 140 according to some embodiments of the invention.

The invention also encompasses a computer program, or a computer program product directly loadable into the internal memory of a computer, or a computer program product stored on a computer readable medium, or a combination of such computer programs or computer program products, for adjusting an projected image 112 on an object 200 using a projection system 100 according to the first aspect of the invention.

The invention also encompasses a computer program, or a computer program product directly loadable into the internal memory of a computer, or a computer program product stored on a computer readable medium, or a combination of such computer programs or computer program products, for projecting an image on an object 200 using the method according to the second aspect of the invention.

1. A metrology system for dimensional measurement of an object comprising:
a light-projection device, LPD, configured to project an image onto the object;
a position-measurement device, PMD, having a measurement volume, configured to determine the position and/or the orientation of the LPD disposed within the measurement volume;
a dimensional acquisition device, DAD, that is an optical non-contact probe rigidly attached to the LPD configured to acquire dimensional data of the object; and
an adjustment unit configured to adjust the projected image to have an essentially static appearance in relation to the object, which adjustment is responsive to movement of the LPD detected by the PMD;
wherein the image projected by the LPD conveys feedback information to the user responsive to dimensional acquisition by the DAD.

2. The metrology system according to claim 1, wherein the adjustment unit further comprises:
a processing device, configured to receive signals from the PMD, process them and output signals to the LPD, wherein the processing device is configured to adjust the position and/or orientation of the projected image to have an essentially static appearance in relation to the object.

3. The metrology system according to claim 1, wherein the DAD is a laser scanner.

4. The metrology system according to claim 2, wherein the processing device is further configured to:
receive a reference model of the object;
receive data from the PMD as to the position and/or orientation of the LPD relative to the object; and
adjust the projected image responsive to the data received from the PMD using the reference model to calculate the adjustment.

5. The metrology system according to claim 2, wherein the processing device is further configured to:
receive a reference model of the object;
receive data from the DAD as to the acquired dimensions of the object; and
adjust the content of the projected image such that the feedback information indicates geometrical deviations between the acquired dimensions of the object and the reference model.

6. The metrology system according to claim 5, wherein the geometrical deviations relate to a dimensional verification of geometrical features of the object.

7. The metrology system according to claim 5, wherein the processing device is further configured such that the feedback information includes suggestions of remedial steps to correct the geometrical deviations in the object.

8. The metrology system according to claim 2, wherein the processing device is further configured to:
receive data from the DAD as to the acquired dimensions of the object; and
adjust the content of the projected image such that the feedback information indicates a local quality of the acquired dimensions of the object.

9. The metrology system according to claim 5, wherein the content of the projected image is continuously updated during dimensional acquisition.

10. The metrology system according to claim 1, wherein the LPD projects the image along a projection beam, wherein the LPD is configured to allow spatial adjustment of the direction of the projection beam.

11. The metrology system according to claim 1, wherein the PMD is configured to determine the 6 degrees of freedom, 6DOF, related to the position and the orientation of the LPD in relation to the object.

12. Use of a metrology system according to claim 1 for dimensional verification of an object.

13. A method for dimensional acquisition of an object, the method comprising:
providing a light-projection device, LPD, configured to project an image onto the object;
providing a position-measurement device, PMD, having a measurement volume, configured to determine the position and/or the orientation of the LPD disposed within the measurement volume;
providing a dimensional acquisition device, DAD, that is an optical non-contact probe rigidly attached to the LPD configured to acquire dimensional data of the object;
moving the DAD relative to the object to acquire dimensions of the object;
adjusting the projected image to have an essentially static appearance in relation to the object, which adjustment is responsive to movement of the LPD detected by the position-measurement device, PMD; and
conveying feedback information to the user responsive to dimensional acquisition by the DAD, via the image projected by the LPD.

14. The method according to claim 13, wherein the steps are iterated in real-time.

15. A non-transitory computer-readable storage medium having stored thereon a set of instructions that specially configure a computing device such that, when executed by one or more processors, the instructions cause the computing device to adjust a projected image on an object, responsive to movement of the LPD of a projection system according to claim 1.
